(19) United States
(12) Patent Application Publication
(10) Pub. No.: US 2006/0183842 A1
(43) Pub. Date: Aug. 17, 2006

(54) Fluoropolymer dispersions with reduced fluorosurfactant content and high shear stability

(76) Inventor: David William Johnson, Washington, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/350,513

(22) Filed: Feb. 9, 2006

Related U.S. Application Data
(60) Provisional application No. 60/651,605, filed on Feb. 10, 2005.
(60) Provisional application No. 60/651,604, filed on Feb. 10, 2005.

(51) Int. Cl. C08L 27/12

(52) U.S. Cl. 524/544

(57) ABSTRACT

An aqueous dispersion comprising fluoropolymer particles, the aqueous dispersion having a fluorinated surfactant content of less than about 300 ppm and containing an aliphatic alcohol ethoxylate nonionic surfactant. The aliphatic alcohol ethoxylate surfactant is an ethoxylate of a saturated or unsaturated secondary alcohol having 8-18 carbon atoms.

### FIELD OF THE INVENTION

The present invention relates to fluoropolymer dispersions with reduced fluorosurfactant content and which exhibit high shear stability.

### BACKGROUND OF THE INVENTION

Fluoropolymers are applied to a wide number of substrates in order to confer release, chemical and heat resistance, corrosion protection, cleanability, low flammability, and weatherability. Coatings of polytetrafluoroethylene (PTFE) homopolymers and modified PTFE provide the highest heat stability among the fluoropolymers, but unlike tetrafluoroethylene (TFE) copolymers, cannot be melt processed to form films and coatings. Therefore other processes have been developed for applying coatings of PTFE homopolymers and modified PTFE. One such process is dispersion coating which applies the fluoropolymer in dispersion form. Dispersion coating processes typically employ such fluoropolymer dispersions in a more concentrated form than the as-polymerized dispersion. These concentrated dispersions contain a significant quantity of nonionic surfactant, e.g. 6-8 weight percent.

For a number of dispersion coating applications such as curtain coating or seriography, a fraction of the coating stream is deposited on the substrate requiring the remainder of the stream to be recycled. The recycled fraction needs to be able to withstand the subsequent multiple pumping and mixing operations necessary for a continuous process. A dispersion suitable for such processing should not easily coagulate when subjected to shearing forces. The resistance of the dispersion to premature coagulation can be measured by a parameter known as gel time and is an indication of the shear stability of the dispersion.

The most commonly used nonionic surfactants in fluoropolymer dispersions have been phenol ethoxylates. However, phenol ethoxylates, can decompose to form harmful compounds that may have adverse environmental impact. In addition, they have the propensity to thermally degrade and cause discoloration to the product, or produce tar-like substances that accumulate on the walls of the baking equipment and can be transferred to the product causing contamination.

Fluorosurfactants are typically used in the dispersion polymerization of fluoropolymers, the fluorosurfactants functioning as a non-telogenic dispersing agent as described in U.S. Pat. No. 2,559,752 to Berry. Unless removed, fluorosurfactant is present in fluoropolymer dispersions. Because of environmental concerns, processes have been developed to reduce the fluorosurfactant content in aqueous fluoropolymer dispersions to decrease emissions of fluorosurfactants and/or decrease or eliminate the need to capture fluorosurfactants during end use processing of fluoropolymer dispersions.

U.S. Pat. No. 6,833,403 to Bladel et al. discloses aqueous dispersions of fluoropolymers with low fluorosurfactant content which are obtained using an anion exchange process to treat stabilized dispersion. Bladel et al. disclose low fluorosurfactant dispersions containing phenol ethoxylate nonionic surfactant as well as low fluorosurfactant dispersions containing aliphatic alcohol ethoxylate nonionic surfactant. For the purposes of fluorosurfactant removal, Bladel et al. discloses that no differences could be observed between phenol ethoxylates type and the aliphatic alcohol ethoxylate. The only aliphatic alcohol ethoxylate employed by Bladel et al is an ethoxylate of isotridecyl alcohol sold under the trademark Genapol® X 080 by Clariant.

However, reduced fluorosurfactant fluoropolymer dispersions containing isotridecyl alcohol ethoxylate surfactant have low gel times. Low gel times in a fluoropolymer dispersion indicate that the dispersion is not well suited for dispersion coating applications such as curtain coating or seriography.

### BRIEF SUMMARY OF THE INVENTION

The invention provides an aqueous dispersion comprising fluoropolymer particles, said aqueous dispersion having a fluorinated surfactant content of less than about 300 ppm and containing an aliphatic alcohol ethoxylate nonionic surfactant, said aliphatic alcohol ethoxylate surfactant being an ethoxylate of a saturated or unsaturated secondary alcohol having 8-18 carbon atoms.

In a preferred form of the invention, fluoropolymer particles comprise non-melt-processible polytetrafluoroethylene or modified polytetrafluoroethylene having an SSG of less than about 2.40.

In another preferred form of the invention, the aliphatic alcohol ethoxylate nonionic surfactant is a compound or mixtures of compounds of the formula:
(R₁)(R₂)CH(OCH₂CH₂)ₙOH
wherein R₁ and R₂ are unbranched or branched alkyl, unbranched or branched alkenyl, cycloalkyl, or cycloalkenyl hydrocarbon groups and the total carbon atoms in R₁ and R₂ is 7-17 and n is an average value of 4 to 18.

The invention provides fluoropolymer dispersions with reduced fluorosurfactant content and high shear stability.

### DETAILED DESCRIPTION OF THE INVENTION

Fluoropolymers

The aqueous fluoropolymer dispersion in accordance with the present invention is made by dispersion polymerization (also known as emulsion polymerization). Fluoropolymer dispersions are comprised of particles of polymers made from monomers wherein at least one of the monomers contains fluorine. The fluoropolymer of the particles of the aqueous dispersions of this invention is independently selected from the group of polymers and copolymers of trifluoroethylene, hexafluoropropylene, monochlorotrifluoroethylene, dichlorodifluoroethylene, tetrafluoroethylene, perfluoroalkyl ethylene monomers, perfluoro(alkyl vinyl ether) monomers, vinylidene fluoride, and vinyl fluoride.

Preferred fluoropolymer particles used in the dispersion employed in this invention are non-melt-processible particles of polytetrafluoroethylene (PTFE) including modified PTFE which is not melt-processible. Polytetrafluoroethylene (PTFE) refers to the polymerized tetrafluoroethylene by itself without any significant comonomer present. Modified PTFE refers to copolymers of TFE with such small concentrations of comonomer that the melting point of the resultant polymer is not substantially reduced below that of PTFE. The concentration of such comonomer is preferably less than 1 wt %, more preferably less than 0.5 wt %. The modified PTFE contains a small amount of comonomer modifier which improves film forming capability during baking (fusing), such as perfluoroolefin, notably hexafluoropropylene (HFP) or perfluoro(alkyl vinyl) ether (PAVE), where the alkyl group contains 1 to 5 carbon atoms, with perfluoro(ethyl vinyl) ether (PEVE) and perfluoro(propyl vinyl) ether (PPVE) being preferred. Chlorotrifluoroethylene (CTFE), perfluorobutyl ethylene (PFBE), or other monomer that introduces bulky side groups into the molecule are also included. In this preferred form of the invention, the PTFE typically has a melt creep viscosity of at least 1×10⁹ Pa·s. The resins in the dispersion used in this form of the invention when isolated and dried are thus non-melt-processible.

By non-melt-processible, it is meant that no melt flow is detected when tested by the standard melt viscosity determining procedure for melt-processible polymers. This test is according to ASTM D-1238-00 modified as follows: The cylinder, orifice and piston tip are made of corrosion resistant alloy, Haynes Stellite 19, made by Haynes Stellite Co. The 5.0 g sample is charged to the 9.53 mm (0.375 inch) inside diameter cylinder which is maintained at 372° C. Five minutes after the sample is charged to the cylinder, it is extruded through a 2.10 mm (0.0825 inch diameter), 8.00 mm (0.315 inch) long square-edge orifice under a load (piston plus weight) of 5000 grams. This corresponds to a shear stress of 44.8 KPa (6.5 pounds per square inch). No melt extrudate is observed.

In one preferred embodiment, the fluoropolymer particles in the dispersion used in this invention comprise a core of high molecular weight polytetrafluoroethylene (PTFE) and a shell of lower molecular weight polytetrafluoroethylene or modified polytetrafluoroethylene.

The preferred non-melt-processible PTFE or modified fPTFE have a standard specific gravity (SSG) of about 2.14 to about 2.50. Preferably, the SSG is less than about 2.40, more preferably less than about 2.30, and most preferably less than about 2.25. The SSG is generally inversely proportional to the molecular weight of PTFE or modified PTFE.

The fluoropolymer particles in the dispersion used in this invention preferably have a number average particle size of about 10 nm to about 400 nm, most preferably, about 100 nm to about 400 nm.

A typical process for the aqueous dispersion polymerization of preferred PTFE polymer is a process wherein TFE vapor is fed to a heated reactor containing fluorosurfactants, paraffin wax and deionized water. A chain transfer agent may also be added if it is desired to reduce the molecular weight of the PTFE. A free-radical initiator solution is added and, as the polymerization proceeds, additional TFE is added to maintain the pressure. The exothermic heat of reaction is removed by circulating cooling water through the reactor jacket. After several hours, the feeds are stopped, the reactor is vented and purged with nitrogen, and the raw dispersion in the vessel is transferred to a cooling vessel. Paraffin wax is removed and the dispersion is isolated and stabilized with nonionic surfactant.

The dispersing agent used in this process is preferably a fluorinated surfactant. The fluorosurfactant in the dispersion is a non-telogenic, anionic dispersing agent, soluble in water and comprising an anionic hydrophilic group and a hydrophobic portion. Preferably, the hydrophobic portion is an aliphatic fluoroalkyl group containing at least four carbon atoms and bearing fluorine atoms and having no more than two carbon atoms not bearing fluorine atoms adjacent to the hydrophilic group. These fluorosurfactants are used as a polymerization aid for dispersing and, because they do not chain transfer, they do not cause formation of polymer with undesirable short chain length. An extensive list of suitable fluorosurfactants is disclosed in U.S. Pat. No. 2,559,752 to Berry. Preferably, the fluorosurfactant is a perfluorinated carboxylic or sulfonic acid having 6-10 carbon atoms and is typically used in salt form. Suitable fluorosurfactants are ammonium perfluorocarboxylates, e.g., ammonium perfluorocaprylate or ammonium perfluorooctanoate. The fluorosurfactants are usually present in the amount of 0.02 to 1 wt % with respect to the amount of polymer formed. The fluorinated surfactant is used to aid the polymerization process but the amount remaining in the dispersion is significantly reduced as will be explained below.

The initiators preferably used to make dispersion of this invention are free radical initiators. They may be those having a relatively long half-life, preferably persulfates, e.g., ammonium persulfate or potassium persulfate. To shorten the half-life of persulfate initiators, reducing agents such as ammonium bisulfite or sodium metabisulfite, with or without metal catalysis salts such as Fe (III), can be used. Alternatively, short half-life initiators such as potassium permanganate/oxalic acid can be used.

In addition to the long half-life persulfate initiators, small amounts of short chain dicarboxylic acids such as succinic acid or initiators that produce succinic acid such as disuccinic acid peroxide (DSP) may be also be added in order to reduce coagulum

To produce dispersion with low fluorosurfactant content as described below, sufficient nonionic surfactant as is described in more detail hereinafter is added to prevent coagulation of the dispersion when the fluorosurfactant content is reduced. The aqueous dispersion can range in fluoropolymer solids content from about 10 to about 70 wt %. Typically, nonionic surfactant is added for stabilization prior to fluorosurfactant reduction and then as desired, concentration of the dispersion is conducted. For concentrating, the polymer is held at a temperature above the cloud point of the nonionic surfactant. Once concentrated to about 30 to about 70 weight % fluoropolymer, and preferably about 45 to about 65 weight % fluoropolymer, the upper clear supernate is removed. Further adjustment of the final solids concentration and surfactant are made as needed. One patent illustrative of a process for concentrating is U.S. Pat. No. 3,037,953 to Marks and Whipple.

Nonionic Surfactants

Nonionic surfactants employed in dispersions in accordance with the invention are ethoxylates of saturated or unsaturated secondary alcohols having 8-18 carbon atoms. Secondary alcohol ethoxylates possess advantages over both primary alcohol ethoxylates and phenol ethoxylates including lower aqueous viscosities, more narrow gel ranges, and less foaming. Moreover, ethoxylates of secondary alcohols provide improved surface tension lowering and thus excellent wetting in end use applications such as coating operations. The nonionic surfactant is preferably present in the dispersion in amounts of about 2 to about 11 wt %, most preferably about 3 to about 11 wt %, based on the weight of the fluoropolymer solids in the dispersion. Suitable nonionic surfactants include any of a variety of ethoxylates of saturated or unsaturated secondary alcohols having 8-18 carbon atoms or mixtures thereof. Preferred surfactants are made from saturated secondary alcohols.

The dispersions in accordance with the invention are essentially free of surfactants containing aromatic groups that can thermally decompose and be converted to harmful organic aromatic compounds that may adversely affect air and water quality during dispersion end use processes. In addition, these materials are prone to producing tar-like buildup on equipment, producing smoke and causing foaming in wash water. Essentially free of surfactants containing aromatic groups preferably means that the dispersions employed contain less than about 0.5 weight % of such surfactants. In end use applications, the surfactants used in this invention burn off cleanly without thermally decomposing on a substrate leaving lower residuals than alkyl phenol ethoxylates.

Especially preferred aliphatic alcohol ethoxylates for use in a dispersion in accordance with the invention are a compound or mixture of compounds of the formula:
(R₁)(R₂)CH(OCH₂CH₂)ₙOH
wherein R₁ and R₂ are unbranched or branched alkyl, unbranched or branched alkenyl, cycloalkyl, or cycloalkenyl hydrocarbon groups and the total carbon atoms in R₁ and R₂ is 7-17 and n is an average value of 4 to 18. Preferably, at least one of R₁ or R₂ is a branched or cyclic hydrocarbon group. The number of ethylene oxide units in the hydrophilic portion of the molecule may comprise either a broad or narrow monomodal distribution as typically supplied or a broader or bimodal distribution which may be obtained by blending.

The cloud point of a surfactant is a measure of the solubility of the surfactant in water. The surfactants employed in the aqueous dispersion of this invention preferably have a cloud point of about 30° C. to about 90° C., preferably about 35° C. to about 85° C.

Preferably, the ethoxylates of saturated or unsaturated secondary alcohols have a static surface tension as 0.1 wt % aqueous solutions at 25° C. of less than about 29 dynes/cm, more preferably less than about 28 dynes/cm.

Nonionic surfactants of the type generally used to stabilize fluoropolymer dispersions can be either liquids or solids at room temperature. If solid, the surfactant tends to be pasty and difficult to handle. They can be handled but often require heated tanks and transfer lines to keep them as a liquid. In addition to the capital cost of the heated equipment, there are operational restrictions placed on the system. If the temperature is maintained too low, tanks and transfer lines can become plugged with solid material. If the temperature is too high, degradation of the surfactant can occur.

Generally low viscosity liquids are preferred from a handling point of view. High viscosity liquids are more difficult to handle and often require heated tanks and lines to keep the viscosity low enough for ease in handling. Some of the apparent liquid surfactants are physically metastable in that they may exist as liquids for several days and then turn into pasty solids. Sometimes water is added to the surfactant to lower its viscosity and making it easier to handle. However, too much water detracts from the desire to produce more concentrated dispersions. A surfactant is considered to be a stable liquid if it remains liquid for 3 days at room temperature after being chilled to 5° C. and then warmed to room temperature (about 23±3° C.).

In accordance with a particularly preferred embodiment of the invention, the nonionic surfactant employed in the aqueous dispersion of the invention is an ethoxylate of 2,6,8-trimethyl-4-nananol. In a more preferred form of this dispersion, the aliphatic alcohol ethoxylate nonionic surfactant comprises ethoxylates of 2,6,8-trimethyl-4-nananol having an average of about 4 to about 12 ethylene oxide (EO) units, most preferably, ethoxylates of 2,6,8-trimethyl-4-nananol having an average about 9 to about 11 ethylene oxide units. Examples of preferred surfactants of this type are those sold under the trademark Tergitol® TMN-6 (nominally 6 EO units) and Tergitol® TMN-10 (nominally 10 EO units) which are available from Dow Chemical Corporation. A blend of 30% Tergitol® TMN-6 and 70% Tergitol® TMN-10 is also available from Dow Chemical Corporation as Tergitol® TMN-100X.

Another suitable ethoxylate of saturated or unsaturated secondary alcohol having 8-18 carbon atoms includes the surfactant sold under the trademark Leocol® TD-90 by the Lion Corporation, Japan. This surfactant is a branched ethoxylate represented by the formula C₁₃H₂₇O (C₂H₄O)₉H formed from a branched secondary alcohol.

Fluorosurfactant Reduction

The aqueous dispersion in accordance with the invention has reduced fluorosurfactant content, i.e., less than about 300 ppm based on the total dispersion weight. Preferably, the fluorosurfactant content is less than about 100 ppm, more preferably less than about 50 ppm.

While any suitable method can be used to reduce fluorosurfactant content, contacting the aqueous dispersion with an anion exchange resin is advantageously used for this purpose. Contacting of the dispersion with anion exchange resin can occur before or after concentration but typically the lower solids material before concentration is easier to process, especially when a fixed bed is employed for carrying out the contacting step. If the process is carried out prior to concentration, nonionic surfactants are added prior to contact with the anion exchange resin as discussed above. Further, it is common to add a nonfluorinated anionic surfactant such as sodium lauryl sulfate to the dispersion prior to concentration to prevent a viscosity increase which can occur upon concentration. A nonfluorinated cationic surfactant can also be used as described in U.S. application Ser. No. 60/638,310, filed Dec. 22, 2004.

Any of a variety of techniques which bring the dispersion in contact with the anion exchange resin can be used to carry out ion exchange of the process. For example, the process can be carried out by addition of ion exchange resin bead to the dispersion in a stirred tank, in which a slurry of the dispersion and resin is formed, followed by separation of dispersion from the anion exchange resin beads by filtration. Another suitable method is to pass the dispersion through a fixed bed of anion exchange resin instead of using a stirred tank. Flow can be upward or downward through the bed and no separate separation step is needed since the resin remains in the fixed bed.

The contacting of the dispersion is performed at a temperature which is sufficiently high to facilitate the rate of ion exchange and to reduce the viscosity of the dispersion but being below a temperature at which the resin degrades at a detrimentally high rate or a viscosity increase in observed. Upper treatment temperature will vary with the type of polymer and nonionic surfactant employed. Typically, temperatures will be between 20° C. and 80° C.

The fluorosurfactant can be recovered from the anion exchange resin if desired or the resin with the fluorosurfactant can be disposed of in an environmentally acceptable method, e.g., by incineration. If it is desired to recover the fluorosurfactant, the fluorosurfactant may be removed from resin by elution. Elution of fluorosurfactant adsorbed on the anion exchange resin is readily achieved by use of ammonia solution as demonstrated by Seki in U.S. Pat. No. 3,882,153, by a mixture of dilute mineral acid with organic solvent (e.g., HCl/ethanol) as demonstrated by Kuhls in U.S. Pat. No. 4,282,162, or by strong mineral acids such as sulfuric acid and nitric, transferring the adsorbed fluorinated carboxylic acid to the eluent. The fluorosurfactant in the eluent in high concentration can easily be recovered in the form of a pure acid or in the form of salts by common methods such as acid-deposition, salting out, and other methods of concentration, etc.

Ion Exchange Resins

The ion exchange resins for use in accordance with reducing the fluorosurfactant content of the aqueous dispersion used in the present invention include anionic resins but can also include other resin types such as cationic resins, e.g., in a mixed bed. The anionic resins employed can be either strongly basic or weakly basic. Suitable weakly basic anion exchange resins contain primary, secondary amine, or tertiary amine groups. Suitable strongly basic anion exchange resin contain quaternary ammonium groups. Although weakly basic resins are useful because they can be regenerated more easily, strongly basis resins are preferred when it is desired to reduce fluorosurfactant to very low levels and for high utilization of the resin. Strongly basic ion exchange resins also have the advantage of less sensitivity to the pH of the media. Strong base anion exchange resins have an associated counter ion and are typically available in chloride or hydroxide form but are readily converted to other forms if desired. Anion exchange resins with hydroxide, chloride, sulfate, and nitrate can be used for the removal of the fluorosurfactant but anion exchange resins in, the form of hydroxide are preferred to prevent the introduction of additional anions and to increase pH during anion exchange because a high pH, i.e., greater than 9, is desirable in the product prior to shipping to inhibit bacterial growth. Examples of suitable commercially-available strong base anion exchange resins with quaternary ammonium groups with a trimethylamine moiety include DOWEX® 550A, US Filter A464-OH, SYBRON M-500-OH, SYBRON ASB1-OH, PUROLITE A-500-OH, Itochu TSA 1200, AMBERLITE® IR 402. Examples of suitable commercially-available strong base anion exchange resins with quaternary ammonium groups with a dimethyl ethanol amine moiety include US Filter A244-OH, AMBERLITE® 410, DOWEX® MARATHON A2, and DOWEX® UPCORE Mono A2.

Ion exchange resin used to reduce fluorosurfactant for use in the process of the present invention is preferably monodisperse. Preferably, the ion exchange resin beads have a number average size distribution in which 95% of the beads have a diameter within plus or minus 100 μm of the number average bead diameter.

The monodisperse ion exchange resin has a particle size which provides a suitable pressure drop through the bed. As discussed previously, very large beads are fragile and prone to breakage. Very small ion exchange beads are susceptible to tight particle packing resulting in tortuous channels in the bed. This can result in high shear conditions in the bed. Preferred ion exchange resin has a number average bead size about 450 to about 800 μm, more preferably, the ion exchange resin beads have a number average bead diameter of about 550 to about 700 μm.

Dispersion Shear Stability

The resistance of the dispersion to premature coagulation can be measured by a parameter known as gel time and is an indication of the shear stability of the dispersion and thus the suitability of dispersions for use in high shear end use applications. Preferred reduced fluorosurfactant aqueous fluoropolymer dispersion in accordance with the invention at about 60 wt % fluoropolymer, at about 6 weight % surfactant and with less than 20 ppm fluorosurfactant has a gel time at least about 10% greater than the same dispersion containing an ethoxylate of isotridecyl alcohol with 8 ethylene oxide units. More preferably, the aqueous dispersion of claim has a gel time of at least about 170 seconds, most preferably, at least about 190 seconds.

End Use Applications

The dispersions of this invention can be used in fluoropolymer coating compositions on any number of substrates including metal and glass and to form multilayer coatings on such substrates, i.e., upper layers of fluoropolymer are coated onto previously formed fluoropolymer layers. The dispersions are applied to substrates and baked to form a baked layer on the substrate. When baking temperatures are high enough, the primary dispersion particles fuse and become a coherent mass. Coating compositions of dispersions of this invention can also be used to coat fibers of glass, ceramic, polymer or metal and fibrous structures such as conveyor belts or architectural fabrics, e.g., tent material. The dispersions of this invention when used to coat metal substrates have great utility in coating cooking utensils such as frying pans and other cookware as well as bakeware and small electrical household appliances such as grills and irons. Dispersions of the invention can be used in these applications for primers coatings and overcoat layers. Coatings employing dispersions of this invention can also be applied to equipment used in the chemical processing industry such as mixers, tanks and conveyors as well as rolls for printing and copying equipment.

Alternately the dispersions can be used to impregnate fibers for sealing applications and filtration fabrics. Further the dispersions of this invention can be deposited onto a support and subsequently dried, thermally coalesced, and stripped from the support to produce self-supporting films cast from the dispersion. Such cast films are suitable in lamination processes for covering substrates of metal, plastic, glass, concrete, fabric and wood.

The dispersions of this invention demonstrate high shear stability. The high shear stability permits these dispersions to withstand forces applied by shear generated by pumping and mixing operations during coating application. High shear stability facilitates internal recycling of coatings necessary for continuous operations for many application processes.

### EXAMPLES

Test Methods

Solids content of raw (as polymerized) fluoropolymer dispersion are determined gravimetrically by evaporating a weighed aliquot of dispersion to dryness, and weighing the dried solids. Solids content is stated in weight % based on combined weights of PTFE and water: Alternately solids content can be determined by using a hydrometer to determine the specific gravity of the dispersion and then by reference to a table relating specific gravity to solids content. (The table is constructed from an algebraic expression derived from the density of water and density of as polymerized PTFE.)

Number average dispersion particle size on raw dispersion is measured by photon correlation spectroscopy.

Standard specific gravity (SSG) of PTFE resin is measured by the method of ASTM D-4895. If a surfactant is present, it can be removed by the extraction procedure in ASTM-D-4441 prior to determining SSG by ASTM D-4895.

Surfactant and solids content of stabilized dispersion are determined gravimetrically by evaporating a small weighed aliquot of dispersion to dryness following in general ASTM D-4441 but using a time and temperature such that water but not the surfactant is evaporated. This sample is then heated at 380° C. to remove the surfactant and reweighed. Surfactant content is stated in wt % based on fluoropolymer solids.

Gel time is measured by the time it takes for concentrated dispersions with reduced fluorosurfactant content to gel when sheared at a high rate. The test is run on fluoropolymer dispersions having 60 percent solids, 6 wt % nonionic surfactant, and less than 20 ppm APFO. 200 ml of dispersion is placed in a Waring commercial explosion resistant blender (Model 707SB, one quart size, 2 speed, air requirements-10 scfm @ 10 psi, available from Waring of New Hartford, Conn.). This blender has a capacity of 1 liter and has an air purge for the motor. The dispersion is stirred at the highest speed until the dispersion gels. The gel point is quite sharp and easy to determine. The gel time is recorded is seconds. If the dispersion does not gel in ½ hour (1800 seconds), the test is terminated to avoid damage to the blender. The blender is then completely disassembled and cleaned after each determination.

### Example

In this Example, the gel times of reduced fluorosurfactant fluoropolymer dispersions in accordance with the invention containing ethoxylates of secondary alcohols as the nonionic surfactant are compared to a reduced fluorosurfactant dispersion containing an ethoxylates of a primary alcohol.

TFE is polymerized to produce a raw PTFE homopolymer dispersion containing PTFE particles having an SSG of about 2.20 and a number average particle size of approximately 220 nm. The raw dispersion contains approximately 45% fluoropolymer solids and has an APFO content of about 1800 ppm. In order to determine gel times, raw dispersion is stabilized, reduced in fluorosurfactant content and concentrated as described below.

Fluorosurfactant reduction is performed using a 14 inch (36 cm) diameter column approximately 8 feet (2.5 meters) long containing a fixed bed of commercially-available strong base anion exchange resin with quaternary ammonium groups with a dimethyl ethanol amine moiety in hydroxide form (A244-OH by US Filter). Approximately 240 gallon quantities of raw dispersions are stabilized by adding the nonionic surfactants identified in Table 1 to provide approximately 4 wt % nonionic surfactant based on the weight of the dispersion. The quantities of each PTFE dispersion are pumped through the column. The APFO level of each dispersion is reduced to less than 20 ppm.

For thermal concentration, 1 liter of each reduced fluorosurfactant dispersion are used. The dispersion is concentrated in glass beakers placed in temperature controlled water baths. Prior to heating, the amount of nonionic surfactant is added to bring the nonionic surfactant level to about 7 wt % based on the amount of water in the dispersion. The beaker is covered with aluminum foil to prevent excess evaporation of water. Once the dispersion has reached the desired concentration temperature, 75° C., the dispersion is stirred and then allowed to remain at 75° C. for 1 hour. The water bath heaters are then turned off and the dispersion is allowed to cool to room temperature. The upper supernate phase is then removed using a water aspirator.

After the supernate is removed, the sample is stirred and the solids content and surfactant are determined by the methods described above. The percent solids are then adjusted to 60% by addition of demineralized water and additional surfactant is then added to increase the surfactant level to 6% based on the PTFE solids. The dispersion is then filtered through a 50 micron filter.

Gel times for each concentrated dispersion are measured using the gel time test method above and are reported in Table 1.

TABLE 1

| | | Cloud | | | | |
|---|---|---|---|---|---|---|
| | Alcohol | Point | Solids | | APFO | Gel Time |
| Surfactant | Structure | ° C. | Content % | Surtactant wt % | (ppm) | (Seconds) |
| Genapol ® | Primary, | 75 | 60 | 6 | <20 | 150 |
| X 080 | Branched | | | | | |
| (Comparative) | | | | | | |
| Tergitol ® | Secondary, | 65 | 60 | 6 | <20 | 210 |
| TMN-100X | branched | | | | | |
| Tergitol ® | Secondary, | 76 | 60 | 6 | <20 | 207 |
| TMN-10 | branched | | | | | |
| Leocol ® TD- | Secondary, | 59 | 60 | 6 | <20 | 175 |
| 90 | branched | | | | | |

What is claimed is:

1. An aqueous dispersion comprising fluoropolymer particles, said aqueous dispersion having a fluorinated surfactant content of less than about 300 ppm and containing an aliphatic alcohol ethoxylate nonionic surfactant, said aliphatic alcohol ethoxylate surfactant being an ethoxylate of a saturated or unsaturated secondary alcohol having 8-18 carbon atoms.

2. The aqueous dispersion of claim 1 wherein said fluoropolymer particles comprise non-melt-processible polytetrafluoroethylene or modified polytetrafluoroethylene having an SSG of less than about 2.40.

3. The aqueous dispersion of claim 1 wherein said fluoropolymer particles comprise non-melt-processible polytetrafluoroethylene or modified polytetrafluoroethylene having an SSG of less than about 2.30.

4. The aqueous dispersion of claim 1 wherein said aliphatic alcohol ethoxylate surfactant has a static surface tension as 0.1 wt % aqueous solutions at 25° C. of less than about 29 dynes/cm.

5. The aqueous dispersion of claim 1 wherein said aliphatic alcohol ethoxylate surfactant has a static surface tension as 0.1 wt % aqueous solutions at 25° C. of less than about 28 dynes/cm.

6. The aqueous dispersion of claim 1 wherein said aliphatic alcohol ethoxylate nonionic surfactant is a compound or mixtures of compounds of the formula:
(R₁)(R₂)CH(OCH₂CH₂)ₙOH
wherein R₁ and R₂ are unbranched or branched alkyl, unbranched or branched alkenyl, cycloalkyl, or cycloalkenyl hydrocarbon groups and the total carbon atoms in R₁ and R₂ is 7-17 and n is an average value of 4 to 18.

7. The aqueous dispersion of claim 6 wherein at least one of R₁ or R₂ is a branched or cyclic hydrocarbon group.

8. The aqueous dispersion of claim 6 wherein said aliphatic alcohol ethoxylate nonionic surfactant is an ethoxylate of 2,6,8-trimethyl-4-nananol.

9. The aqueous dispersion of claim 6 wherein said aliphatic alcohol ethoxylate non ionic surfactant is an ethoxylate of 2,6,8-trimethyl-4-nananol and n is 4 to 12.

10. The aqueous dispersion of claim 6 wherein said aliphatic alcohol ethoxylate nonionic surfactant is an ethoxylate of 2,6,8-trimethyl-4-nananol and n is 9 to 11.

11. The aqueous dispersion of claim 1 wherein said dispersion is essentially free of surfactants containing aromatic groups.

12. The aqueous dispersion of claim 1 wherein said dispersion has a fluorinated surfactant content of less than about 100 ppm.

13. The aqueous dispersion of claim 1 wherein said dispersion has a fluorinated surfactant content of less than about 50 ppm.

14. The aqueous dispersion of claim 1 wherein said dispersion at about 60 wt % fluoropolymer, at about 6 weight % surfactant and with less than 20 ppm fluorosurfactant has a gel time at least about 10% greater than the same dispersion containing an ethoxylate of isotridecyl alcohol with 8 ethylene oxide units.

15. The aqueous dispersion of claim 1 wherein said dispersion at about 60 wt % fluoropolymer, at about 6 weight % surfactant and with less than 20 ppm fluorosurfactant has a gel time of at least about 190 seconds.

16. The aqueous dispersion of claim 1 wherein said dispersion at about 60 wt % fluoropolymer and at about 6 weight % surfactant has a gel time of at least about 200 seconds.

17. The aqueous dispersion of claim 1 wherein said fluoropolymer solids content is about 10 to about 70 wt %.

18. The aqueous dispersion of claim 1 comprising about 2 to about 11 wt % nonionic surfactant based on the weight of fluoropolymer solids in said dispersion.

19. The aqueous dispersion of claim 1 wherein said fluoropolymer particles have a number average particle size of about 10 to about 400 nm.

20. The aqueous dispersion of claim 1 wherein said fluoropolymer particles have a number average particle size of about 100 to about 400 nm.

21. The aqueous dispersion of claim 1 wherein said aliphatic alcohol ethoxylate surfactant is an ethoxylate of a saturated secondary alcohol having 8-18 carbon atoms.
